(19) United States
(12) Patent Application Publication
(10) Pub. No.: US 2007/0242290 A1
(43) Pub. Date: Oct. 18, 2007

(54) Image processing apparatus, image forming apparatus and image processing method

(75) Inventors: Toru Misaizu, Kanagawa (JP); Masaaki Fukuhara, Kanagawa (JP); Kazuo Asano, Kanagawa (JP); Takeshi Saito, Kanagawa (JP); Kazuhiro Hama, Kanagawa (JP); Toshio Hisamura, Kanagawa (JP); Toshiki Matsui, Kanagawa (JP); Yasuhiro Arai, Kanagawa (JP); Kenji Koizumi, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/592,131

(22) Filed: Nov. 3, 2006

(30) Foreign Application Priority Data
Apr. 17, 2006 (JP) P2006-113183

(51) Int. Cl. G06F 15/00

(52) U.S. Cl. 358/1.9; 358/3.06

(57) ABSTRACT

An image processing apparatus includes an input section, and a screen processing section. The input section inputs image information. The screen processing section performs screen processing on the input image information with a threshold matrix. A plurality of threshold values are arranged in the threshold matrix so that if the threshold values are colored in an ascending order or descending order. The threshold matrix represents at least one selected from the group consisting of capital alphabets ‘A’ to ‘Z’, lower case alphabets ‘a’ to ‘z’ and numeric characters ‘0’ to ‘9.’

### BACKGROUND

### TECHNICAL FIELD

The invention relates to an image forming apparatus and the like for forming on a recording medium an image of a document prepared by a computer or the like.

In recent years, remarkable progress has been made in the hardware and software for multimedia and DTP. Electronic documents (including drawings, photographic images, etc.) such as office documents and various electronic documents for other applications have also become complex. As such, there have been increasing demands for outputting those electronic documents at higher speed with higher image quality and with greater ease by means of various image forming apparatuses.

### SUMMARY

According to an aspect of the invention, an image processing apparatus includes an input section, and a screen processing section. The input section inputs image information. The screen processing section performs screen processing on the input image information with a threshold matrix. A plurality of threshold values are arranged in the threshold matrix so that if the threshold values are colored in an ascending order or descending order. The threshold matrix represents at least one selected from the group consisting of capital alphabets ‘A’ to ‘Z’, lower case alphabets ‘a’ to ‘z’ and numeric characters ‘0’ to ‘9.’

### BRIEF DESCRIPTION OF THE DRAWINGS

Exemplary embodiments will be descried in detail below with reference to the accompanied drawings wherein:

FIG. 1 is a diagram illustrating the overall configuration of a printer system to which this exemplary embodiment is applied;

FIG. 2 is a block diagram illustrating the configuration of an image processing system to which this exemplary embodiment is applied;

FIG. 3 is a flowchart illustrating the flow of image processing;

FIG. 4 is a diagram illustrating a drawing matrix whose threshold values depict “A” of the alphabet;

FIG. 5 is a diagram showing a state where respective image densities are represented (depicted) with black and white dots based on the threshold matrix shown in FIG. 4;

FIG. 6 is a diagram illustrating one example in which a photograph (raster image) is subjected to screen processing by using the drawing matrix;

FIG. 7 is a diagram illustrating one example in which a graphic is subjected to screen processing by using the drawing matrix;

FIG. 8 is an image diagram in a state in which a dot matrix of a character font is passed through a low-pass filter;

FIGS. 9A to 9C are diagrams illustrating a general cyclic matrix method;

FIG. 10 is a flowchart of screen processing; and

FIGS. 11A and 11B are diagrams explaining a general sequential computation-type irrational tangent method.

### DETAILED DESCRIPTION

Referring now to the accompanying drawings, a detailed description will be given on exemplary embodiments.

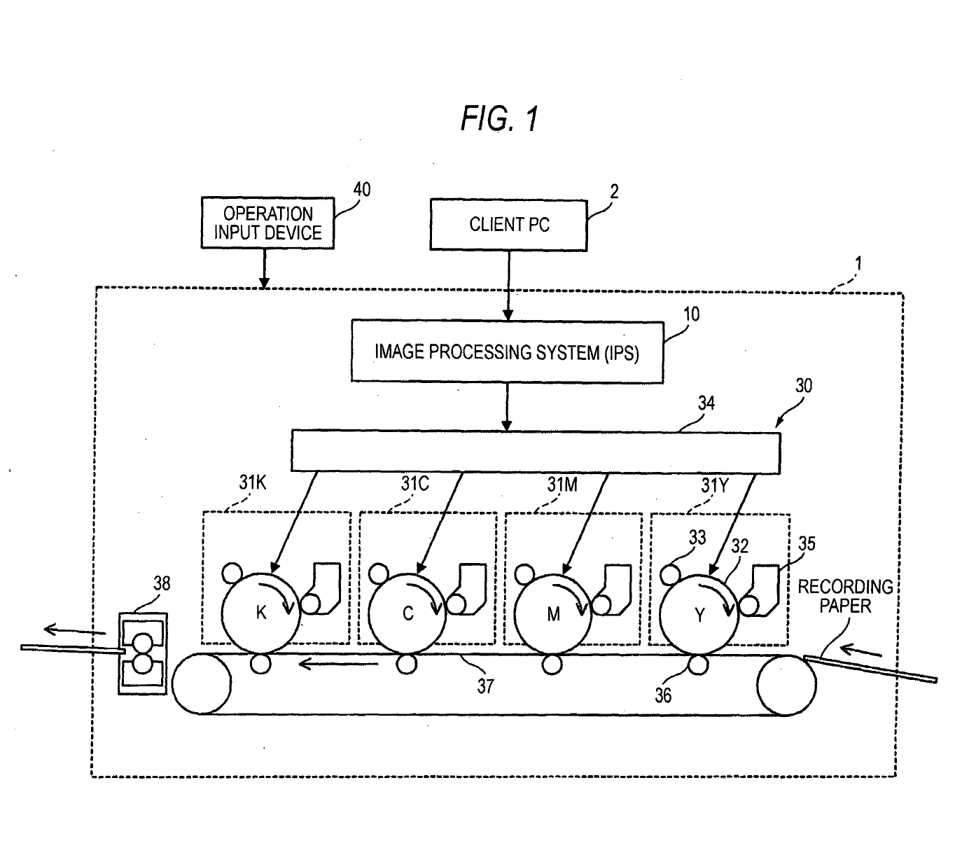

FIG. 1 is a diagram illustrating the overall configuration of a printer system to which this exemplary embodiment is applied. FIG. 1 shows an image forming apparatus 1, which develops information of an input electronic document into an image and prints the image on paper, and a client PC (personal computer) 2, which is a host computer for providing electronic documents to this image forming apparatus 1. Image data may be input to this image forming apparatus 1 from an image reading apparatus (not shown) or an image input terminal (IIT), which is other than the client PC 2.

The image forming apparatus 1 includes an image processing system (IPS) 10 for performing predetermined image processing on the image data of the electronic document output from, for instance, the client PC 2, and a marking engine 30 serving as an image forming unit. Here, the marking engine 30 is a so-called tandem-type digital color printer, which employs the electrophotographic system. The image forming apparatus 1 further includes an operation input device 40 such as a keyboard for inputting setting information.

The marking engine 30 includes plural image forming units 31 (31Y, 31M, 31C, and 31K) arranged in parallel at regular intervals in the horizontal direction and an exposure device 34 for exposing photoconductor drums 32 of the respective image forming units 31.

These image forming units 31 (31Y, 31M, 31C, and 31K) respectively form toner images of yellow (Y), magenta (M), cyan (C), and black (K) and consecutively transfer the toner images onto a recording paper, which serves as a recording medium. It should be noted that each of these image forming units will be referred to as the image forming unit 31 unless a description for each color is otherwise required.

Although a detailed description will be omitted, the exposure device 34 is a multi-beam scanning device for causing plural laser beams, which are emitted from a surface-emitting laser array chip having a group of plural light-emitting points, to collectively undergo scanning operation so as to be guided to the photoconductor drums 32 of the respective image forming units 31. As a result, image formation with a resolution of 2400 dpi is made possible.

Each of the four image forming units 31 includes: the photoconductor drum 32 serving as an image carrier on which an electrostatic latent image is formed and which carries a toner image; a charger 33 for uniformly charging the surface of the photoconductor drum 32; and a developer 35 for developing the electrostatic latent image formed by the exposure device 34. In addition, each of the four image forming units 31 further includes a transfer roll 36 for transferring the toner image formed on the surface of the photoconductor drum 32 onto the recording paper.

Further, the marking engine 30 includes a paper transport belt 37 for transporting the recording paper to a transfer position formed by the photoconductor drum 32 and the transfer roll 36 of each image forming unit 31. The marking engine 30 further includes a fixing device 38 for fixing the toner image transferred onto the paper.

It should be noted that it is not necessary for an image processing apparatus to include the entire image forming apparatus 1, but that the image processing apparatus may include only the image processing section.

The respective image forming units 31 have substantially similar constituent elements except for the color of the toner accommodated in the developer 35. The image data input from the client PC 2 is subjected to image processing by the image processing system 10, and is supplied to the marking engine 30 through a predetermined interface. The marking engine 30 operates on the basis of control signals such as a synchronization signal supplied from an image output controlling unit (not shown). First, the image forming unit 31Y of yellow (Y) forms an electrostatic latent image by the exposure device 34 on the basis of a photoconductor image signal charged by the charger 33. A toner image of yellow (Y) is formed with respect to that electrostatic latent image by the developer 35, and the toner image of yellow (Y) thus formed is transferred onto the recording paper on the paper transport belt 37, which rotates in the direction of the arrow in the drawing, by using the transfer roll 36. Similarly, toner images of magenta (M), cyan (C), and black (K) are respectively formed on the respective photoconductor drums 32, and are multiple-transferred onto the recording paper on the paper transport belt 37 by using the transfer rolls 36. The multiple-transferred toner image on the recording paper is transferred to the fixing device 38, and is fixed to the paper by heat and pressure.

It should be noted that the marking engine 30 of the image forming apparatus 1 shown in FIG. 1 adopts the configuration in which he toner images are consecutively transferred onto the recoding paper being transferred. However, it is possible to adopt an image forming apparatus of the so-called secondary transfer system in which, by adopting a so-called intermediate transfer belt instead of the paper transfer belt 37, the toner images are multiple-transferred onto this intermediate transfer belt, and are subsequently secondarily transferred onto the paper collectively.

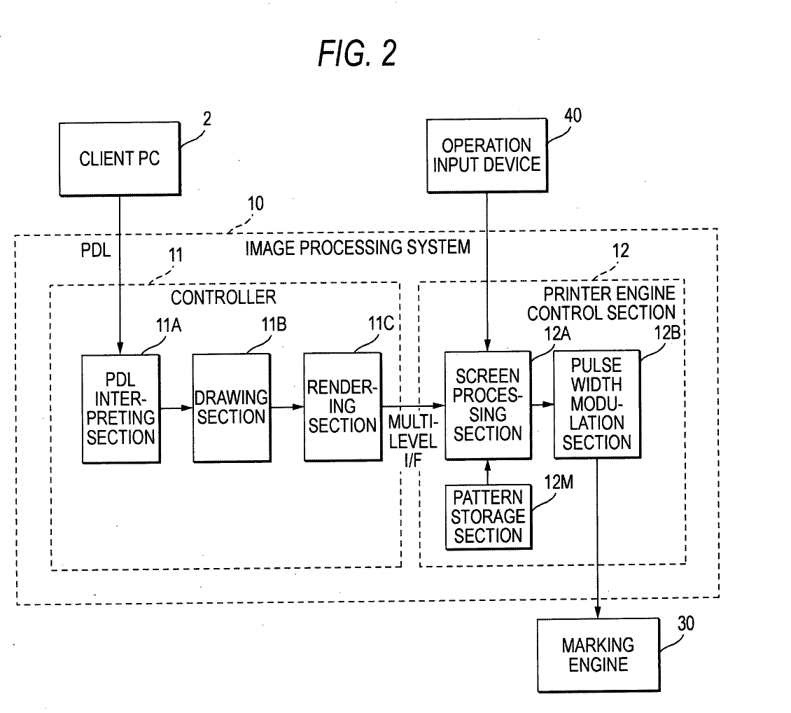

Next, a description will be given on the image processing system 10. FIG. 2 is a block diagram illustrating the configuration of the image processing system 10 to which this exemplary embodiment is applied. The image processing system includes a controller 11, which serves as an input unit, and a printer engine control section 12. It should be noted that, in this exemplary embodiment, such an example of the configuration is shown that upon receiving image data of a PDL (page description language) format from an external personal computer (e.g. client PC 2), the marking engine 30 forms an image.

The controller 11 has a PDL interpreting section 11A, a drawing section 11B and a rendering section 11C.

The PDL interpreting section 11A interprets commands of the PDL (page description language), which is sent from the client PC 2.

The drawing section 11B converts color signals (e.g. R, G, and B) designated by the interpreted PDL into color signals (e.g. Y, M, C, and K) of the marking engine 30. The drawing section 11B classifies images to be drawn into respective objects such as a photograph (raster image), a character (font) and a chart (graphic), and attaches object tags to the respective images. In addition, at the time of drawing, the drawings section 11B converts raster data such as a raster image into the engine resolution of the marking engine 30, while drawing the character and the graphic with intermediate codes of the engine resolution.

The rendering section 11C renders the intermediate codes into image data conforming to the printer engine.

The printer engine control section 12 has a screen processing section 12A and a pulse width modulation section 12B. The printer engine control section 12 further has a pattern storage section 12M for storing plural threshold matrices, which are used when the screen processing section 12A performs screen processing.

The screen processing section 12A performs the screen processing (binarization processing) by the dither method, which is one of area gradation methods. The screen processing section 12A performs this screen processing using the threshold matrices stored in the pattern storage section 12M. The threshold matrices will be described later in detail.

The pulse width modulation section 12B performs pulse width modulation on the image data subjected to the screen processing, and supplies an image signal to the marking engine 30.

The image processing system 10 configured as described above performs image processing in the following steps.

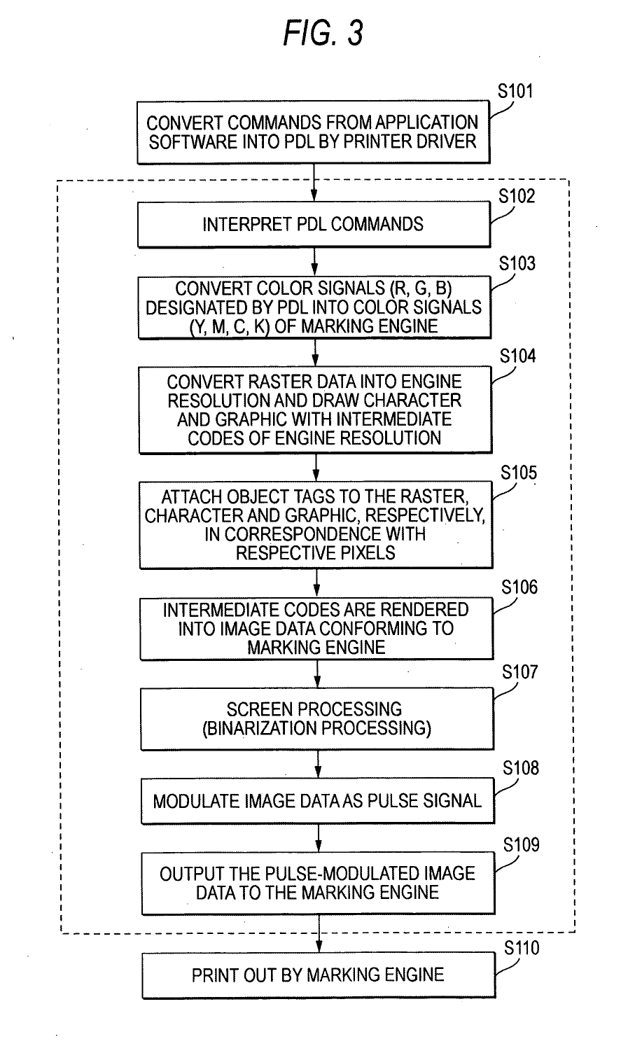

FIG. 3 is a flowchart illustrating the flow of image processing, which is executed by the image processing system 10 and the marking engine 30. Steps 102 through 110 are processing, which is executed by the image processing system 10. Reference numerals of the respective operating portions are shown in FIG. 2.

First, the printer driver of the client PC 2 converts the commands from an application program into the PDL (page description language), which provides drawing commands of the printer (Step 101).

The drawing commands of the PDL are sent from the client PC 2 to the image forming apparatus 1. In the image processing system 10 of this image forming apparatus 1, the PDL interpreting section 11A interprets the acquired PDL commands (Step 102).

Subsequently, the drawing section 11B converts the color signals (R, G, and B) designated by the interpreted PDL into color signals (Y, M, C, and K) of the marking engine 30 (Step 103). When drawing, the drawing section 11B converts raster data such as a raster image into the engine resolution of the marking engine 30, while drawings the character and the graphic with intermediate codes of the engine resolution (Step 104). Further, the drawings section 11B attaches object tags to the raster, the character, and the graphic, respectively, when drawing (Step 105).

Subsequently, the rendering section 11C renders these intermediate codes into image data conforming to the marking engine 30 (Step 106).

The rendered image data is sent to the screen processing section 12A of the printer engine control section 12 through, for example, an B-bit multi-level interface. Then, the screen processing section 12A performs the screen processing (binarization processing) on the sent image data (Step 107).

The screen processing section 12A reads a desired threshold matrix from the pattern storage section 12M, and performs the screen processing on the sent image data. This screen processing will be described later in detail.

Subsequently, the image data subjected to the screen processing is input to the pulse width modulation section 12B of the printer engine control section 12. The pulse width modulation section 12B modulates the image data, which is subjected to the screen processing by the screen processing section 12A, as a pulse signal (Step 108). The pulse-modulated image data is output to the marking engine 30 (Step 109). Upon acquiring the image data, the marking engine 30 forms a color image on a recording paper by the respective constituent elements shown in FIG. 1, and prints it out (Step 110).

Next, a detailed description will be given on the screen processing section 12A and its screen processing. It should be noted that the screen processing is performed on image information of the respective colors Y, M, C, and K. However, in the following description, a description will be given only on K (black) as an example.

The screen processing section 12A reads a threshold matrix corresponding to the setting condition, from among the plural threshold matrices (drawing matrices and normal matrices, which will be described later in detail) stored in the pattern storage section 12M. Then, the screen processing section 12A performs the screen processing (binarization processing). At that time, since the screen processing section 12A performs the screen processing using the drawing matrix, specific information, which the drawing matrix has, is added to a halftone portion.

The threshold matrix used in the screen processing includes a matrix of plural thresholds. The screen processing superposes the threshold matrix on the input image, compares each threshold value of the threshold matrix with a gray level of a corresponding pixel and converts the respective pixels into binary expression (that is, black or white) to thereby represent gray scale. Namely, the screen processing depicts a predetermined region of the input image with black and white of plural pixels on the output side, to represent the gray scale (gradation) of the pixels of the input image by the area ratio of black to white.

Here, this exemplary embodiment employs, as threshold matrices, drawing matrices in which threshold values are so arranged to depict concrete shapes by relative magnitudes of the threshold values. The “concrete shapes” referred to here may include capital alphabets ‘A’ to ‘Z’, lower case alphabets ‘a’ to ‘z’ and numerical characters ‘0’to ‘9’. The drawing matrices whose threshold values depict these concrete shapes are respectively formed in advance, and are stored in the pattern storage section 12M. In addition, normal threshold matrices (e.g., dot matrices, line matrices and square matrices, which are hereinafter referred to as “normal matrices”) whose threshold values do not depict concrete shapes are also stored in the pattern storage section 12M.

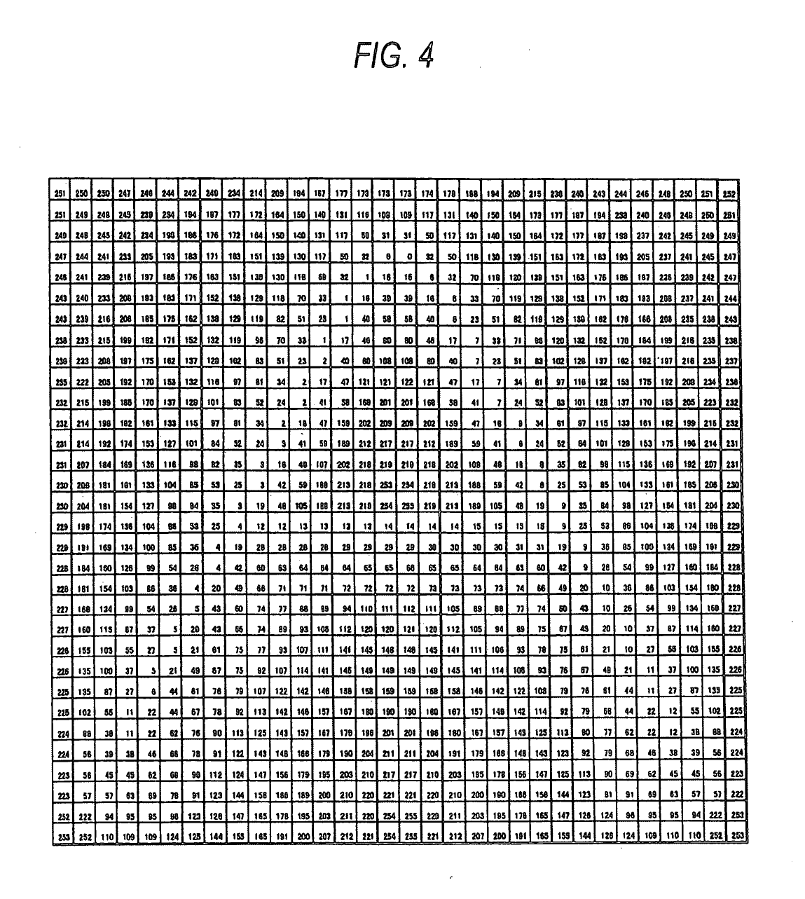

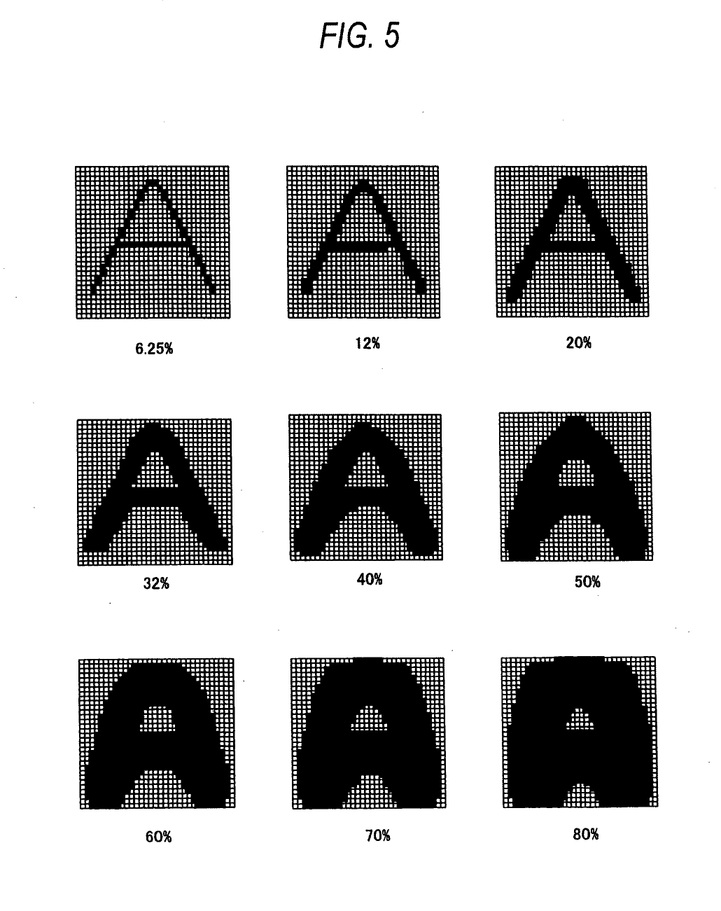

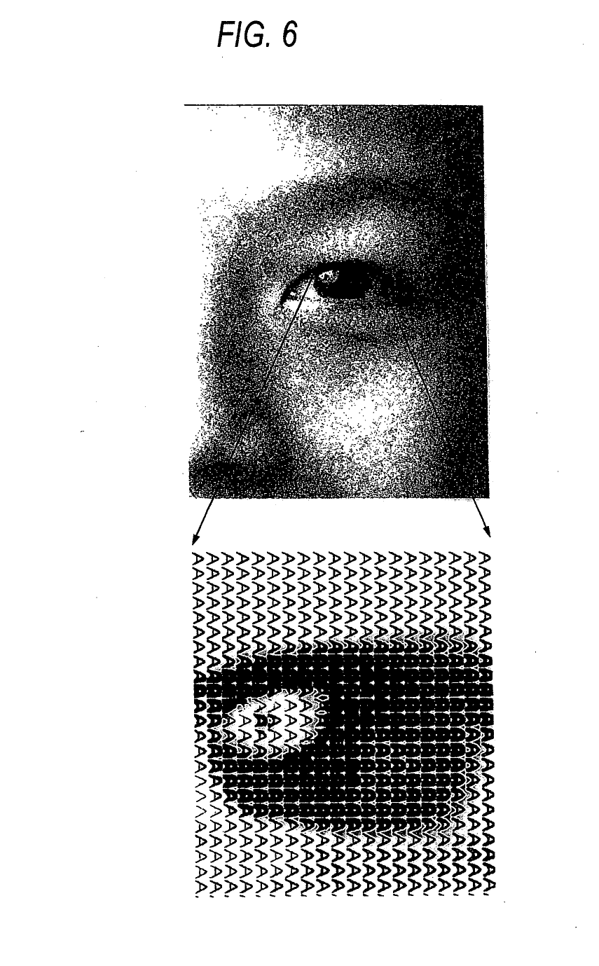

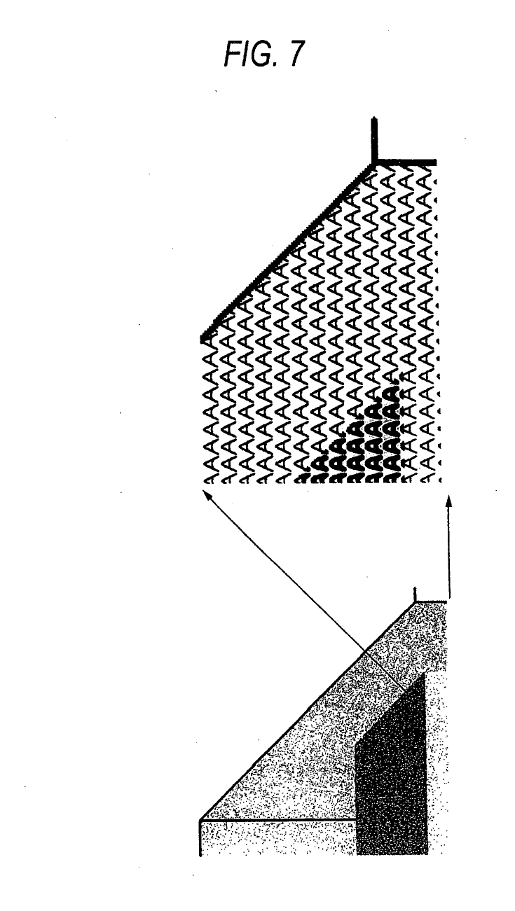

As one example of the drawing matrices, FIG. 4 shows a threshold matrix whose threshold values depict “A” of the alphabet. Further, FIG. 5 shows a state where respective image densities are represented (depicted) with black and white dots based on the threshold matrix shown in FIG. 4. Furthermore, FIG. 6 is a diagram illustrating one example in which the screen processing is performed on a photograph (raster image) by using the drawing matrix shown in FIG. 4. FIG. 7 is a diagram illustrating one example in which the screen processing is performed on a graphic by using this drawing matrix. The drawing matrix shown in FIG. 4 includes 32×32 threshold values, and the numerical values shown in FIG. 4 are the respective threshold values. These threshold values correspond to an image having 256 gradations. The threshold values are set in a range of from “0” to “255.” The reason for using a square of 32×32 is that concrete shapes such as characters can be formed in the square in the definite form, and that when characters formed in squares are arranged so as to form a character string, the squares can be arranged orderly.

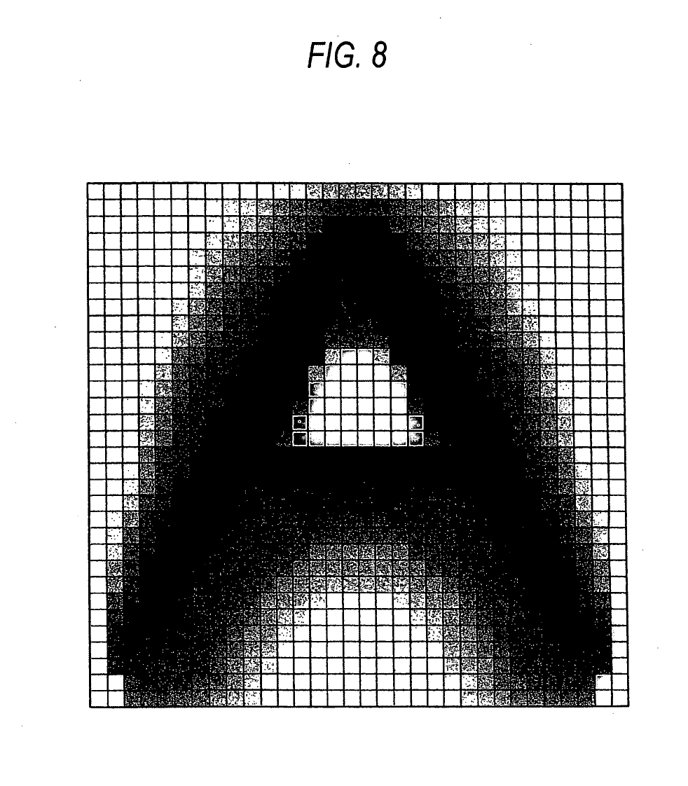

In forming the drawing matrix, image information of a character font is developed into a bit map of a predetermined number of pixels (32×32), and the character information of this bit map is passed through a low-pass filter to form character information having gradation. Then, threshold values in ascending order may be allotted to the respective pixels in descending order of density so as to form the drawing matrix. FIG. 8 is an image diagram showing image information of a bit map, which is passed through a low-pass filter. As to a character, which is formed in a halftone portion by performing the screen processing by using the drawing matrix thus formed, a size of a line forming the character gradually changes from a thin linear shape to a thick shape so that the entire line becomes thicker averagely as the image density to be represented becomes higher. It should be noted that the above-described drawing matrix is arranged to form a character with black dots (with a high density), but may be arranged to form a character with white dots (with a low density).

The screen processing section 12A performs the screen processing using such a drawing matrix by, for example, a cyclic matrix method.

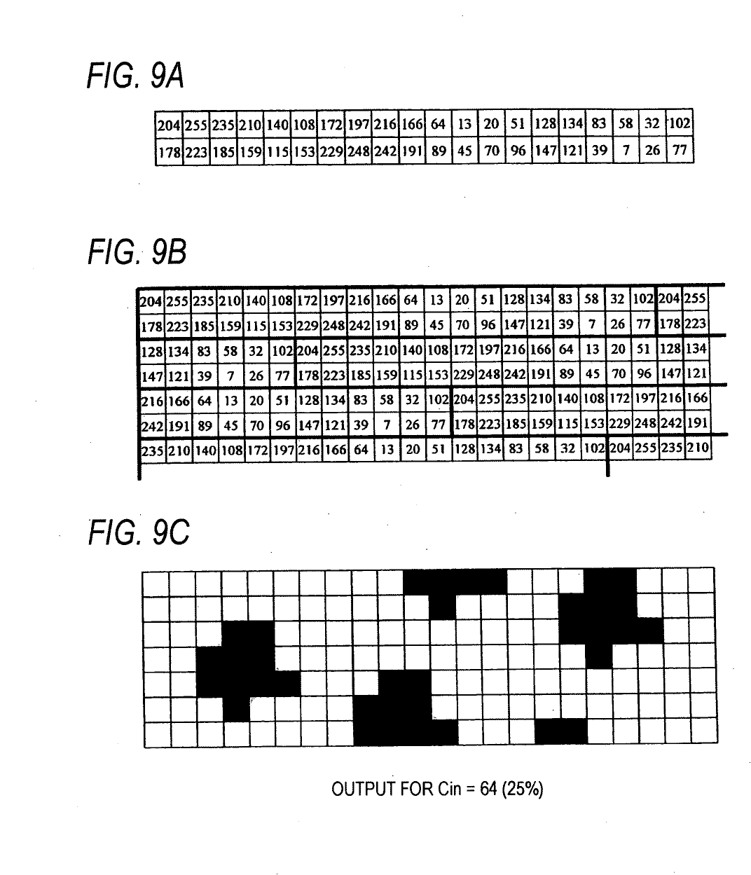

FIGS. 9A to 9C are diagrams illustrating a general cyclic matrix method.

The cyclic matrix method arranges a threshold matrix, for example, shown in FIG. 9A in the form of tiles as shown in FIG. 9B, and compares respective threshold values with a magnitude of a density of the input image so as to binarize the input image. FIG. 9C shows an output with a density of 25%. In such a cyclic matrix method, the lines in inch and angles are set to fixed levels by the arrangement of the threshold matrix.

By performing such screen processing using the drawing matrix, the very small characters “A” are drawn in the halftone portions of the formed image, and the gradations are represented by these characters “A.” Namely, portions with low densities are formed of the characters “A” drawn by thin lines, while portions with high densities are formed of the characters “A” drawn by thick lines, thereby representing gradations. Portions whose gradations are intermediate or in their vicinities are formed of relatively clear “A”s. Namely, the character information of “A” is added (embedded) to the halftone portions of the formed image in the form of characters.

Here, the marking engine 30 of this exemplary embodiment forms an image with 2400 dpi, and the lines per inch is 75 when the threshold matrix of 32×32 pixels is used.

It is said that, in the visual characteristics of a human being, structural recognition is difficult when the lines in inch is 75 or thereabouts. On the other hand, if 16×16 to 32×32 pixels are present, it is possible to form character information therein.

Accordingly, if 75 lines in inch and the threshold matrix of 32×32 pixels are used as in this exemplary embodiment, although the characters are formed in the halftone portions, it is practically impossible to read the characters by human's eyes. However, if the characters are viewed in enlarged form by using a magnifying lens, it becomes possible to recognize the characters. For this reason, if the user knows that the characters are embedded, the user is able to confirm the embedded characters with a simple tool such as a magnifying lens. In other words, it is possible to form an image so that although the characters are not recognizable at a glance, if the user knows in advance, the user is able to confirm the characters easily and identify a type of the printed material.

In this exemplary embodiment, plural drawing matrices for forming the alphabet, various symbols and numerals are provided, as described above, and an arbitrary character string can be formed by combining them.

Namely, by performing the screen processing using the respective drawing matrices subsequently so as to correspond to a desired character string, it is possible to add a character string to halftone portions of a formed image. However, if the number of characters is too large, the characters don't appear continuously in the halftone portions. Thus, it is necessary to set the number of characters to an appropriate number.

The screen processing section 12A operates, as described below, and performs screen processing by using the threshold matrices (drawing matrices and normal matrices) such as those described above.

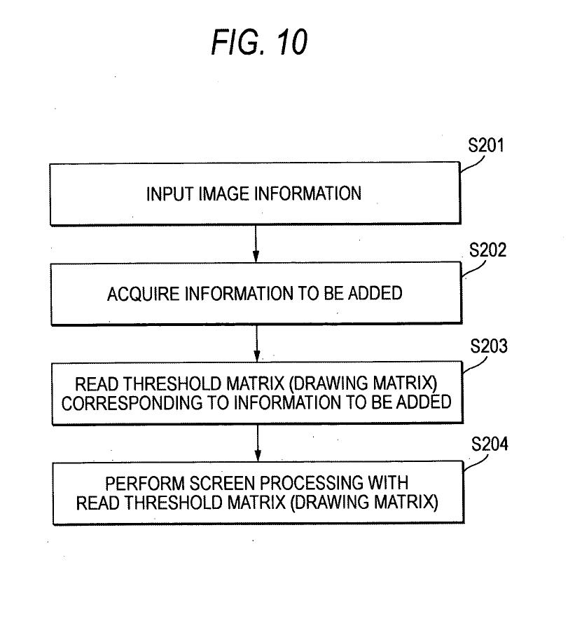

FIG. 10 is a flowchart of the screen processing process by the screen processing section 12A.

Namely, when image information is input from the controller 11 (rendering section 11C) (Step 201), the screen processing section 12A acquires information to be added to the input image information (Step 202).

Examples of the information to be added may include user information such as a name held by the client PC 2 (or a name input through the client PC 2), date, printing conditions such as a printing mode and a paper size, information of management number of the client PC 2 on the network, and information of peculiar serial number, which is specific information of the image forming apparatus 1.

Next, the screen processing section 12A reads a threshold matrix (drawing matrix) corresponding to the information to be added from the pattern storage section 12M (Step 203). Then, the screen processing section 12A performs the screen processing using the read threshold matrix (drawing matrix) by, for example, the cyclic matrix method, as described above (Step 204).

Here, it is possible to limit a region to which the information is added. If limited, a drawing matrix is used only for that limited region, and a normal matrix is used for regions other than the limited region.

Namely, in the case where information is added only to an image of a specific type, the screen processing section 12A judges a type of the image information based on the object tag, which is attached by the drawings section 11B and indicates one of raster, character and graphic as a type of the image information. Then, the screen processing section 12A changes the threshold matrix in accordance with the judged type and performs the screen processing using the threshold matrix. For example, if information is added to a photograph (image) region, deterioration of the image quality is concerned. Therefore, the screen processing section 12A may use a normal matrix for the photograph (image) region. In this case, the screen processing section 12A uses a drawing matrix only for a graphic. Namely, information is added only to the graphic region.

It is noted that information to be added is not limited to the alphabets and numeric characters exemplified above. Examples of the information to be added may include hiragana characters, katakana characters, Chinese characters (kanji) and other types of characters. Also, it is noted that the concrete shape depicted by the drawings matrix is not limited to characters, but may include any shape having significance. Examples of the concrete shape depicted by the drawings matrix may include various symbols and graphic symbols such as character marks, symbol marks and cooperation marks.

Further, the method of performing the screen processing is not limited to the cyclic matrix method. It is possible to use other methods such as a super cell method using a larger threshold matrix and a sequential computation-type irrational tangent method.

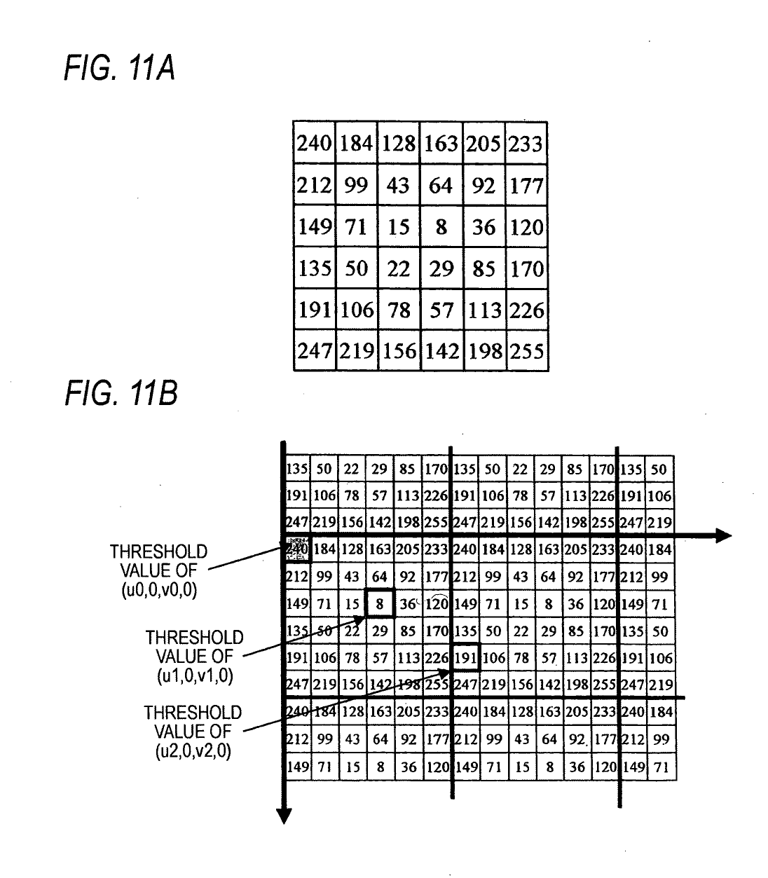

FIGS. 11A and 11B are diagrams explaining a general sequential computation-type irrational tangent method, in which FIG. 11A shows a threshold matrix.

In the sequential computation-type irrational tangent method, by using the following mathematical formula, coordinate values (Ux, y, Vx, y) of a UV coordinate system, i.e., a coordinate system of a desired screen, are determined from coordinate values (x, y) of an xy coordinate system, i.e., a coordinate system of an image by assuming that the magnification is K and the angle is θ.

$$( \begin{matrix}{u}_{x , y} \\ {v}_{x , y}\end{matrix} ) = K ( \begin{matrix}cos θ & - sin θ \\ sin θ & cos θ\end{matrix} ) ( \begin{matrix}x \\ y\end{matrix} )$$

Then, as shown in FIG. 11B, binarization is effected by making a comparison between a threshold value of the threshold matrix at the coordinate values (Ux, y, Vx, y) of the determined uv coordinate system and the density of the coordinate values (x, y) of the image.

If the configuration is provided to perform screen processing by such a sequential computation-type irrational tangent method, it is possible to arbitrarily set angles and the lines in inch by using one threshold matrix. For this reason, a configuration can be provided to arbitrarily set the angles and the lines in inch on the basis of the setting information input through the operation input device 40 (see FIG. 2).

In addition, a region to which information is added may not be limited according to the image object (object tag). The region to which information is added may be set as a specific region in the same plane. For example, the drawing matrix is applied to a limited region such as a title portion and a portion where a certain mark is displayed.

Further, the screen processing section 12A may change the threshold matrix according to an image formation mode of the image forming apparatus 1. For example, when an image is formed with high resolution, the screen processing section 12A stops applying the drawings matrices and only uses the normal matrices, to thereby form the image with high quality.

Furthermore, if an image forming apparatus is one for forming a color image as in this exemplary embodiment, the screen processing section 12A may apply the drawings matrices only to a yellow image, which is difficult to recognize.

What is claimed is:

1. An image processing apparatus comprising:
an input section that inputs image information;
a screen processing section that performs screen processing on the input image information with a threshold matrix, wherein:
a plurality of threshold values are arranged in the threshold matrix so that if the threshold values are colored in an ascending order or descending order, and
the threshold matrix represents at least one selected from the group consisting of capital alphabets ‘A’ to ‘Z’, lower case alphabets ‘a’ to ‘z’ and numeric characters ‘0’ to ‘9.’

2. The image processing apparatus according to claim 1, wherein the selected at least one represented by the threshold values of the threshold matrix increases in an area as the threshold values increase or decrease while representing a similarity shape to the selected at least one.

3. The image processing apparatus according to claim 1, wherein the threshold values of the threshold matrix increase in order of densities of pixels generated by applying a low pass filter to a bit map, which represents the selected at least one and has number of pixels corresponding to the threshold matrix.

4. The image processing apparatus according to claim 1, wherein the screen processing section changes between the threshold matrix and another threshold matrix, which does not represent any one selected from the group consisting of capital alphabets ‘A’ to ‘Z’, lower case alphabets ‘a’ to ‘z’ and numeric characters ‘0’ to ‘9,’ in accordance with an image object indicated by the image information, to perform the screen processing.

5. The image processing apparatus according to claim 4, wherein if the image object is graphic, the screen processing section performs the screen processing with the threshold matrix.

6. The image processing apparatus according to claim 1′, wherein:
if the threshold values of the threshold matrix are colored in the ascending order or descending order, the selected at least one represented by the threshold matrix increases in an area as a maximum value of the colored threshold values increases or decreases while having a similarity shape to the selected at least one.

7. An image processing apparatus comprising:
an input section that inputs image information; and
a screen processing section that performs screen processing on the image information input by the input unit, with a threshold matrix, wherein:
in the threshold matrix, a plurality of threshold values are arranges so as to represent a concrete shape.

8. The image processing apparatus according to claim 7, wherein the concrete shape expressed by the threshold values of the threshold matrix is a character.

9. The image processing apparatus according to claim 7, wherein the concrete shape expressed by the threshold values of the threshold matrix is a symbol.

10. The image processing apparatus according to claim 7, wherein the concrete shape expressed by the threshold values of the threshold matrix is a graphic symbol.

11. The image processing apparatus according to claim 7, wherein the concrete shape represented by the threshold values of the threshold matrix increases in an area as the threshold values increase while representing a similarity shape.

12. An image forming apparatus comprising:
an image processing section that performs screen processing on input image information, with a threshold matrix wherein a plurality of threshold values are arranges in the threshold matrix so as to represent one selected from the group consisting of capital alphabets ‘A’ to ‘Z’, lower case alphabets ‘a’ to ‘z’ and numeric characters ‘0’ to ‘9’; and
an image forming section that forms an image on a recording medium based on the image information, which is screen processed by the image processing section.

13. The image forming apparatus according to claim 12, wherein the one represented by the threshold values of the threshold matrix increases in an area as the threshold values increase or decrease while representing a similarity shape.

14. The image forming apparatus according to claim 12, wherein:
the image processing section includes a plurality of threshold matrices, which represent different ones selected from the group consisting of capital alphabets ‘A’ to ‘Z’, lower case alphabets ‘a’ to ‘z’ and numeric characters ‘0’ to ‘9’, and
the image processing section performs the screen processing with the plurality of threshold matrices.

15. The image forming apparatus according to claim 14, wherein:
the image processing section reads designation information by a user, and
the image processing section performs the screen processing with at least one of threshold matrices, which corresponds to the designation information.

16. The image forming apparatus according to claim 14, wherein:
the image processing section reads predetermined information held on a transmission source of the input image information, and
the image processing section performs the screen processing with at least one of the threshold matrices, which corresponds to the predetermined information.

17. The image forming apparatus according to claim 14, wherein:
the apparatus has unique specific information, and
the image processing section performs the screen processing with at least one of the threshold matrices, which corresponds to the specific information.

18. The image forming apparatus according to claim 14, wherein:
the image processing section further comprises another threshold matrix, which does not represent any one selected from the group consisting of capital alphabets ‘A’ to ‘Z’, lower case alphabets ‘a’ to ‘z’ and numeric characters ‘0’ to ‘9’, and
the image processing section can change between the threshold matrices and the other threshold matrix, to perform the screen processing.

19. The image forming apparatus according to claim 18, wherein:
the image forming section has a plurality of image formation modes, and
the image processing section changes between the threshold matrices and the other threshold matrix in accordance with the image formation mode, to perform the screen processing.

20. The image forming apparatus according to claim 18, wherein:
the image forming section comprises an image forming unit that forms an image of a plurality of colors, and
the image processing section changes between the threshold matrices and the other threshold matrix in accordance with the color, to perform the screen processing.

21. An image processing method comprising:
inputting image information;
reading a threshold matrix in which a plurality of threshold values are arranged so as to represent one selected from the group consisting of capital alphabets ‘A’ to ‘Z’, lower case alphabets ‘a’ to ‘z’ and numeric characters ‘0’ to ‘9’; and
performing screen processing on the input image information with the read threshold matrix.

22. The method according to claim 21, wherein:
image type identification information is attached to the input image information, and
the performing of the screen processing comprises:
changing between the threshold matrix and another threshold matrix, which does not represent any selected one, in accordance with the image type identification information; and
performing the screen processing on the input image information with the changed threshold matrix.
